(19) United States
(12) Patent Application Publication
(10) Pub. No.: US 2022/0161431 A1
(43) Pub. Date: May 26, 2022

(54) METHOD FOR DETERMINING A TRAJECTORY OF A ROBOT

(71) Applicant: Siemens Aktiengesellschaft, München (DE)

(72) Inventors: Philine Meister, Mountain View, CA (US); Werner Neubauer, München (DE); Kai Wurm, München (DE)

(21) Appl. No.: 17/602,303

(22) PCT Filed: Apr. 2, 2020
(86) PCT No.: PCT/EP2020/059331

§ 371 Date: Oct. 8, 2021

(30) Foreign Application Priority Data
Apr. 16, 2019 (EP) 19169506.3

(51) Int. Cl. B25J 9/16

(52) U.S. Cl. CPC B25J 9/1664

(57) ABSTRACT

A method for determining a trajectory of a robot from a starting position to a target position is provided. The starting position and the target position are manually defined by a user in a real environment of the robot. Then a collision-free trajectory of the robot from the starting position to the target position is determined, based on the surroundings of the robot. Also provided is a device, a robot system, a computer program and a machine-readable storage medium.

### CROSS-REFERENCE TO RELATED APPLICATIONS

This application claims priority to PCT Application No. PCT/EP2020/059331, having a filing date of Apr. 2, 2020, which claims priority to EP Application No. 19169506.3, having a filing date of Apr. 16, 2019, the entire contents both of which are hereby incorporated by reference.

### FIELD OF TECHNOLOGY

The following relates to a method for determining a trajectory of a robot from a starting position to a target position. The following also relates to an apparatus, a robot system, a computer program and a machine-readable storage medium.

### BACKGROUND

It is known practice to teach a trajectory of a robot from a starting position to a target position in a completely manual manner. In this case, the robot is moved into a starting position and a target position, wherein a user then respectively specifies by an input that these are the starting and target positions, respectively.

A trajectory between this starting position and this target position is then determined manually by the user using a plurality of intermediate positions. That is to say, the user moves the robot into a plurality of intermediate positions which are on a desired trajectory. Each time an intermediate position is approached, provision is made for the user to again manually specify to the robot by an input that this position should be approached.

The robot will then approach the intermediate positions taught in this manner in succession by carrying out a rectilinear movement between two intermediate positions.

In this case, the user himself must determine and stipulate the trajectory between the starting position and the target position. There is no computer-implemented calculation of the trajectory using an environmental model.

It is also known practice to simulate an environment of the robot. A user stipulates a starting position and a target position in such a simulated environment. A trajectory between this starting position and this target position in the simulated environment is then calculated in a computer-implemented manner.

The published patent application US 2017/0210008 A1 discloses a method for determining a trajectory of a robot from a starting position to a target position.

The published patent application US 2019/0015980 A1 discloses a method for determining a trajectory of a robot from a starting position to a target position.

The published patent application US 2019/0039242 A1 discloses a method for determining a trajectory of a robot from a starting position to a target position.

### SUMMARY

An aspect relates to providing a concept for efficiently determining a trajectory of a robot from a starting position to a target position.

A first aspect provides a method for determining a trajectory of a robot from a starting position to a target position, comprising:
receiving first user input signals representing a first user input at a first point in time stating that a first current position of the robot at the first point in time should be stored as a starting position,
storing the first current position of the robot as a starting position in response to the reception of the first user input signals,
receiving second user input signals representing a second user input at a second point of time, which differs from the first point in time, stating that a second current position of the robot at the second point in time should be stored as a target position,
storing the second current position of the robot as a target position in response to the reception of the second user input signals,
receiving environmental signals which represent an environment of the robot, and
determining a collision-free trajectory of the robot from the stored starting position to the stored target position on the basis of the environment of the robot.

A second aspect provides an apparatus which is configured to carry out the method according to the first aspect.

A third aspect provides a robot system comprising a robot and the apparatus according to the second aspect.

A fourth aspect provides a computer program comprising instructions which, when the computer program is executed by a computer, cause the latter to carry out a method according to the first aspect.

A fifth aspect provides a machine-readable storage medium which stores the computer program according to the fourth aspect.

Embodiments of the invention are based on the knowledge that the above object can be achieved by the user stipulating both the starting position and the target position in the real environment of the robot by a user input.

A trajectory between the starting position and the target position is then automatically determined, in which case the environment of the robot is taken into account in order to determine a collision-free trajectory from the starting position to the target position.

That is to say, according to the concept described here, provision is made, in particular, for a user to move the robot to a first position, wherein the user then stipulates, by a first user input, that this first position is either the starting position or the target position.

Provision is also made, in particular, for the user to move the robot into a second position. The user then again carries out a second user input in order to stipulate that this second position is the target position or the starting position.

Therefore, provision is not made for the user to stipulate the starting position and the target position in a simulated environment. The starting position and the target position are therefore stipulated in the real environment of the robot. The starting position and the target position are therefore real positions.

In contrast, the trajectory from the starting position to the target position no longer needs to be determined by the user. Rather, this determination is carried out in a computer-implemented manner. That is to say, this determination can be carried out without the assistance of the user.

Some partial aspects of the procedures described in the introductory part of the description are therefore synergistically combined with one another. The advantages of both procedures are picked out as it were, with the result that the best of both procedures is synergistically combined: on the one hand, the computer-implemented automatic determination of a collision-free trajectory from a starting position to a target position. On the other hand, the simple stipulation of the starting position and the target position in the real world. The user therefore need not have any knowledge of how a computer program for determining a trajectory must be operated, for example.

It suffices for the user to move the robot to the appropriate positions in order to then stipulate, by a simple user input, that these are the starting position and target position, respectively.

Furthermore, the technical advantage that a trajectory can be taught efficiently, conveniently and quickly is achieved, for example.

In particular, the technical advantage that a concept for efficiently determining a trajectory of a robot from a starting position to a target position is provided is therefore achieved.

The environment of the robot, which is represented by the environmental signals, is, for example, a real environment, a simulated and/or virtual environment, resp., or a combined real/simulated virtual (simulated) environment.

A virtual or simulated environment of the robot is determined by a CAD environment, for example.

A real environment of the robot is determined, for example, using one or more environmental sensors. That is to say, an environment of the robot is captured using such an environmental sensor or using a plurality of such environmental sensors, wherein a real environment of the robot is determined on the basis of the corresponding capture.

An environmental sensor is, for example, one of the following environmental sensors: radar sensor, ultrasonic sensor, video sensor, lidar sensor or a magnetic field sensor.

In a combined real/virtual environment of the robot, one or more elements of the environment are simulated, in particular, and one or more elements of the environment are real, in particular, that is to say are captured using one or more environmental sensors, in particular.

One embodiment provides for third user input signals to be received and to represent a third user input at a third point in time stating that a third current position of the robot at the third point in time should be stored as an intermediate position, wherein the third point in time differs from the first point in time and differs from the second point in time, wherein the third current position of the robot at the third point in time is stored in response to the reception of the third user input signals, wherein the trajectory is determined on the basis of the stored intermediate position in such a manner that the stored intermediate position is on the trajectory.

This achieves the technical advantage, for example, that the trajectory can be determined efficiently. In particular, this achieves the technical advantage that the user can efficiently stipulate one or more intermediate positions which are intended to be approached by the robot.

One embodiment provides for trajectory signals representing the determined collision-free trajectory to be generated and output.

This achieves the technical advantage, for example, that the determined trajectory can be provided efficiently.

One embodiment provides for a plurality of collision-free trajectories of the robot from the stored starting position to the stored target position to be determined on the basis of the environment of the robot.

Embodiments which relate to a collision-free trajectory similarly apply to a plurality of collision-free trajectories and vice versa. That is to say, if “trajectory” is in the singular, the plural should always be inferred and vice versa. Statements which are made in connection with a trajectory similarly apply to a plurality of trajectories and vice versa.

The same similarly applies to the intermediate position. That is to say, one embodiment provides for a plurality of intermediate positions to be on the determined trajectory. Accordingly, provision is then made, for example, for fourth, fifth and, in particular, any desired further user input signals representing a fourth, a fifth and any desired corresponding further user inputs at a corresponding point in time to be received stating that a correspondingly current position of the robot at the corresponding point in time should be stored as a corresponding intermediate position.

One embodiment provides for robot control signals for controlling the robot to be generated on the basis of the determined trajectory and on the basis of a predefined maximum speed and to be output in such a manner that, when controlling the robot on the basis of the robot control signals, the robot moves from the starting position to the target position along the determined trajectory at the predefined maximum speed.

This achieves the technical advantage, for example, that the determined trajectory in the real environment can be efficiently checked by a user. As a result of the fact that the robot moves in this case only at the predefined maximum speed, safety can be efficiently increased. If the determined trajectory is incorrect, for example, the severity of a collision in the event of a possible collision can be efficiently reduced by virtue of the predefined maximum speed. A predefined maximum speed is, for example, 25 cm/s, for example 3.3 cm/s, for example 5 cm/s, for example less than or less than or equal to 5 cm/s.

For moving parts in automated manufacturing systems, that is to say for the robot in the present case, in particular for the individual joints of the robot, VDI 2854 provides a “safely” reduced speed of at most 25 cm/s in the case of dangerous movements without a risk of crushing and shearing (by abutment) and of at most 3.3 cm/s in the case of dangerous movements with a risk of crushing and shearing. The restoring speed of power-operated, isolating protective devices should be <=5 cm/s (DIN EN 12203).

Predefining an appropriate maximum speed achieves the technical advantage, in particular, that the relevant standards can be complied with.

One embodiment provides for display control signals to be generated on the basis of the determined trajectory and on the basis of the environment of the robot and to be output in such a manner that, when controlling a display device on the basis of the display control signals, the determined trajectory is displayed together with the environment of the robot by the display device.

This achieves the technical advantage, for example, that the determined trajectory can be checked efficiently. This embodiment therefore provides for the determined trajectory to be displayed to a user, with the result that the user can visually check it efficiently.

According to one embodiment, a display device comprises one or more screens.

A screen is, for example, a touch-sensitive screen, called a “touchscreen”.

A screen is included, for example, in a terminal, for example a mobile terminal, for example a smartphone or a tablet.

That is to say, the user can check the determined trajectory using his mobile terminal, for example.

The fact that the determined trajectory is displayed together with the environment of the robot by the display device achieves the technical effect that the determined trajectory can be efficiently checked in order to determine whether there may be a collision between the robot and an element in the environment without a collision between the robot and this element or object taking place in the real world.

The display of the determined trajectory together with the environment should be understood here, in particular, in the sense of an “augmented reality”.

One embodiment provides for boundary condition signals representing a boundary condition for the trajectory to be determined to be received, wherein the trajectory is determined on the basis of the boundary condition.

This achieves the technical advantage, for example, that the trajectory can be determined efficiently. In particular, this achieves the technical advantage that the user can efficiently influence the trajectory to be determined.

A boundary condition stipulates, for example, a location and/or pose, resp., of the robot and/or a gripper of the robot, an orientation of the robot and/or a gripper of the robot in a particular position and/or during a movement along the trajectory to be determined, resp.

If a trajectory which satisfies the boundary condition cannot be determined, one embodiment provides for the boundary condition to be adapted in such a manner that it is possible to determine a trajectory which satisfies the adapted boundary condition, with the result that the trajectory is determined on the basis of the adapted boundary condition.

This achieves the technical advantage, for example, that a trajectory can be determined even when the boundary condition initially cannot be satisfied.

A boundary condition to be complied with may be, for example, a region which must not be entered by the robot. Another boundary condition may be the fact that a particular orientation of the gripper must be complied with. Both boundary conditions can then be less restrictive.

The adaptation of a boundary condition therefore means, for example, that the two boundary conditions mentioned above are less restrictive.

Statements which are made in connection with a boundary condition similarly apply to a plurality of boundary conditions and vice versa. That is to say, if “boundary condition” is in the singular, the plural should always be inferred and vice versa. In the case of a plurality of boundary conditions, they are different, for example.

In the case of a plurality of boundary conditions, one embodiment provides for them to be weighted differently, wherein the respective weighting indicates whether and, if so, the order in which the corresponding boundary condition can be adapted.

In the case of a plurality of boundary conditions, one embodiment provides for notification signals, which represent a notification of which the boundary conditions have been adapted, to be output.

This achieves the technical advantage, for example, that the user is efficiently able to then decide whether or not to agree to the corresponding adaptation.

One embodiment provides for a plurality of collision-free trajectories respectively comprising a shortest trajectory and/or a fastest trajectory and/or a smoothest trajectory from the starting position to the target position to be determined.

This achieves the technical advantage, for example, that the user can be efficiently provided with a selection of possible collision-free trajectories. The user can therefore select whether to have the shortest trajectory, the fastest trajectory or the smoothest trajectory.

A smoothest trajectory is understood by a person skilled in the art as meaning an energy-optimized trajectory, that is to say a trajectory having the lowest energy consumption, which in turn also comprises slight acceleration changes (“smoothest trajectory”).

A “smoothest trajectory” should be considered here, in particular, in relation to a time-optimized trajectory (“fastest trajectory”) which is the fastest trajectory and has severe acceleration changes, which may mean greater mechanical wear.

A “smoothest trajectory” should be considered here, in particular, in relation to a geometrically shortest trajectory (“shortest trajectory”).

One embodiment provides for robot parameter signals representing a robot parameter of a further robot in the environment of the robot to be received, wherein the trajectory is determined on the basis of the robot parameter, wherein the robot parameter is an element selected from the following group of robot parameters: further starting position of a further trajectory of the further robot, further target position of a further trajectory of the further robot, further trajectory of the further robot from a further starting position to a further target position, dimension of the further robot, contour of the further robot.

This achieves the technical effect, for example, that the existence of a further robot in the environment of the robot can be efficiently taken into account when determining the collision-free trajectory.

One embodiment provides for the method to be carried out or performed by the apparatus.

Apparatus features similarly emerge from corresponding method features and vice versa. That is to say, in particular, technical functionalities of the method similarly emerge from corresponding technical functionalities of the apparatus and vice versa.

The wording “resp.” stands for the wording “respectively”, in particular, which stands for “and/or”, in particular.

According to one embodiment, a robot comprises one or more robot arms which are each connected to one another in an articulated manner by a joint.

According to one embodiment, a robot comprises one or more grippers.

The determination of the collision-free trajectory from the starting position to the target position comprises, in particular, determining a separate collision-free sub-trajectory for each of the robot arms.

The determination of the collision-free trajectory from the starting position to the target position comprises, in particular, determining a separate collision-free sub-trajectory for each of the grippers.

According to one embodiment, a man-machine interface or, according to one embodiment, a plurality of man-machine interfaces is/are provided for the purpose of capturing the corresponding user input.

According to one embodiment, a man-machine interface is an element selected from the following group of man-machine interfaces: keyboard, touch-sensitive screen, mouse, button, switch.

For example, provision is made for such a man-machine interface to be arranged on the robot.

According to one embodiment, a touch-sensitive screen may be provided both as a man-machine interface and for the purpose of displaying the determined trajectory, in particular together with the environment of the robot in the sense of an augmented reality.

According to one embodiment, the method according to the first aspect is a computer-implemented method.

According to one embodiment, the determination of the trajectory is a computer-implemented determination.

A position in the sense of the description, that is to say, in particular, a starting position, a target position and an intermediate position, stipulates, in particular, a spatial position of the robot and/or an orientation of the robot and/or an orientation of a gripper of the robot and/or an orientation of a robot arm.

The fastening point of the robot is generally fixed, apart from when the robot arm is fastened to further moving axes. In this case, these axes become part of the robot kinematics with these additional movement axes. The robot position can be stipulated in two ways: the spatial position of the gripper can be calculated with the aid of the “forward kinematics” using the positions of all joint values (rotational or translational).

The joint values of the robot can be calculated with the aid of the “inverse kinematics” using the spatial position of the gripper, that is to say its position and orientation.

One embodiment provides a robot control device which is configured to control the robot, in particular to control a movement of the robot. According to one embodiment, the robot is controlled on the basis of the determined trajectory.

According to one embodiment, the method comprises displaying the determined trajectory by the display device.

According to one embodiment, the method comprises controlling the robot, in particular controlling the robot on the basis of the determined trajectory and the predefined maximum speed.

According to one embodiment, the first point in time is before the second point in time. According to one embodiment, the second point in time is before the first point in time.

That is to say, provision is made, for example, for the starting position to be stored first of all and then the target position, or vice versa.

That is to say, in particular, the user can first of all stipulate the starting position and then the target position or vice versa according to one embodiment.

The same similarly applies to storing the intermediate position at the third point in time. The third point in time may therefore be, in particular, before the first point in time or after the first point in time or before the second point in time or after the second point in time or between the first point in time and the second point in time.

That is to say, in particular, an intermediate position can be stored first of all, in which case the starting position and then the target position or vice versa are only then stored.

That is to say, a user does not stipulate which of the positions he would like to store in which order.

The same similarly applies to receiving the environmental signals which represent an environment of the robot.

This step can be carried out at any desired point in time. That is to say, for example, the individual positions are first of all stipulated, in which case the environmental signals are only then received. For example, provision may also be made for the environmental signals to first of all be received, in which case the positions are only then stipulated.

That is to say, in particular, the step of receiving environmental signals can be carried out at any desired point in time in the sequence of the method as long as this step is carried out before the step of determining a collision-free trajectory of the robot.

### BRIEF DESCRIPTION

Some of the embodiments will be described in detail, with references to the following Figures, wherein like designations denote like members, wherein:

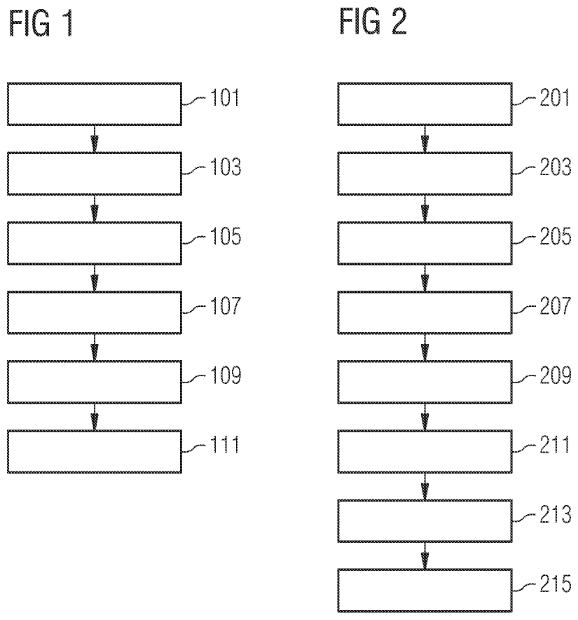

FIG. 1 shows a flowchart of a first method for determining a trajectory of a robot;

FIG. 2 shows a flowchart of a second method for determining a trajectory of a robot;

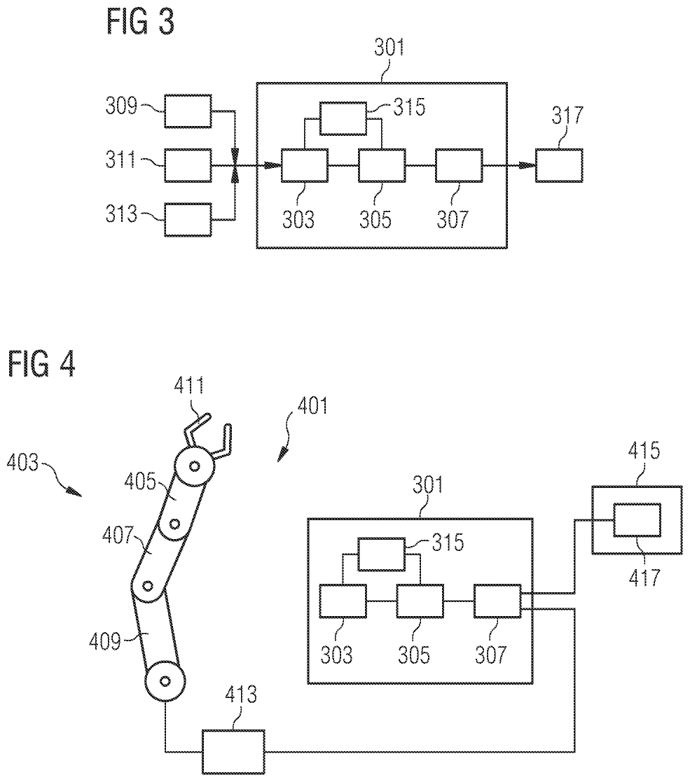

FIG. 3 shows an apparatus;

FIG. 4 shows a robot system comprising a robot;

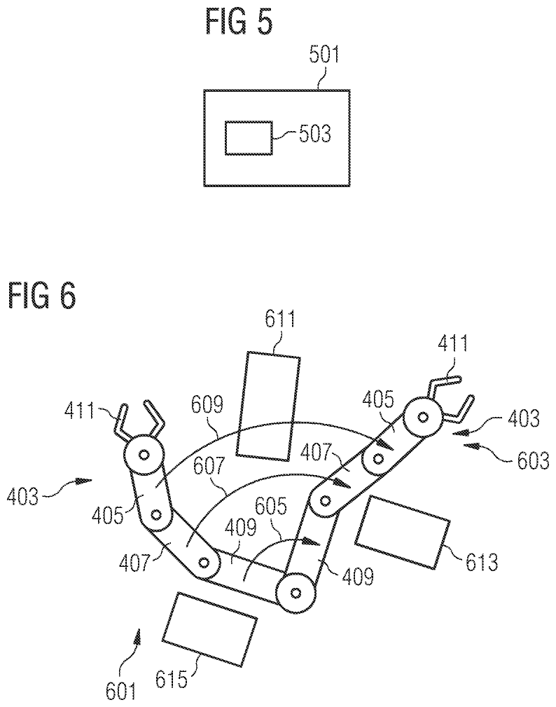

FIG. 5 shows a machine-readable storage medium; and

FIG. 6 shows the robot shown in FIG. 4 in a starting position and in a target position.

### DETAILED DESCRIPTION

FIG. 1 shows a flowchart of a first method for determining a trajectory of a robot from a starting position to a target position.

The method comprises:
receiving 101 first user input signals representing a first user input at a first point in time stating that a first current position of the robot at the first point in time should be stored as a starting position,
storing 103 the first current position of the robot as a starting position in response to the reception of the first user input signals,
receiving 105 second user input signals representing a second user input at a second point of time, which differs from the first point in time, stating that a second current position of the robot at the second point in time should be stored as a target position,
storing 107 the second current position of the robot as a target position in response to the reception of the second user input signals,
receiving 109 environmental signals which represent an environment of the robot, and
determining 111 a collision-free trajectory of the robot from the stored starting position to the stored target position on the basis of the environment of the robot.

FIG. 2 shows a flowchart of a second method for determining a trajectory of a robot from a starting position to a target position.

The method comprises:
receiving 201 first user input signals representing a first user input at a first point in time stating that a first current position of the robot at the first point in time should be stored as a starting position,
storing 203 the first current position of the robot as a starting position in response to the reception of the first user input signals,
receiving 205 second user input signals representing a second user input at a second point of time, which differs from the first point in time, stating that a second current position of the robot at the second point in time should be stored as a target position,
storing 207 the second current position of the robot as a target position in response to the reception of the second user input signals,
receiving 209 environmental signals which represent an environment of the robot, and
determining 211 a collision-free trajectory of the robot from the stored starting position to the stored target position on the basis of the environment of the robot.

According to a step 213, provision is made for robot control signals for controlling the robot to be generated on the basis of the determined trajectory and on the basis of a predefined maximum speed in such a manner that, when controlling the robot on the basis of the robot control signals, the robot moves from the starting position to the target position along the determined trajectory at the predefined maximum speed.

The method also comprises a step 215 of outputting the generated robot control signals.

Alternatively, or additionally, step 213 may provide for display control signals to be generated on the basis of the determined trajectory and on the basis of the environment of the robot in such a manner that, when controlling a display device on the basis of the display control signals, the determined trajectory is displayed together with the environment of the robot by the display device.

Alternatively, or additionally, step 215 may provide for the generated display control signals to be output.

FIG. 3 shows an apparatus 301.

The apparatus 301 is configured to carry out the method according to the first aspect.

The apparatus 301 comprises an input 303, a processor 305 and an output 307.

The input 303 is configured to receive environmental signals 309 which represent an environment of the robot.

The input 303 is also configured to receive first user input signals 311 representing a first user input at a first point in time stating that a first current position of the robot at the first point in time should be stored as a starting position.

The input 303 is also configured to receive second user input signals 313 representing a second user input at a second point in time, which differs from the first point in time, stating that a second current position of the robot at the second point in time should be stored as a target position.

The apparatus 301 also comprises a memory device 315 which is configured to store the first current position of the robot as a starting position and is configured to store the second current position of the robot as a target position.

The memory device 315 comprises, for example, one or more memories, for example electronic and/or magnetic memories. For example, the memory device 315 comprises one or more hard disks and/or one or more SSDs (“Solid State Disk”).

The processor 305 is configured to determine a collision-free trajectory of the robot from the starting position to the target position on the basis of the stored starting position, on the basis of the stored target position and on the basis of the environment.

The processor 305 is also configured to generate trajectory signals 317 representing the determined collision-free trajectory on the basis of the determined trajectory.

The output 307 is configured to output the generated trajectory signals 317.

For example, provision is made for the generated trajectory signals 317 to be output to a robot control device which controls the robot on the basis of the determined trajectory in such a manner that the robot moves along the collision-free trajectory from the starting position to the target position.

For example, provision is made for the trajectory signals 317 to be output to a display device which then displays the determined trajectory, in particular together with the environment of the robot.

Provision is generally made for signals which are received to be received by the input 303. The input 303 is therefore accordingly configured to receive such signals.

Signals which are output are generally output by the output 307, for example. That is to say, the output 307 is configured, in particular, to output such signals.

If one embodiment provides for an intermediate position to be stored, provision is made, for example, for the intermediate position to be stored in the memory device 315.

FIG. 4 shows a robot system 401.

The robot system 401 comprises the apparatus 301 shown in FIG. 3.

The robot system 401 also comprises a robot 403 comprising a first robot arm 405, a second robot arm 407 and a third robot arm 409. The first robot arm 405 is connected to the second robot arm 407 in an articulated manner. The second robot arm 407 is connected to the third robot arm 409 in an articulated manner.

A gripper 411 is arranged on the first robot arm 405.

The robot system 401 comprises a robot control device 413 which is configured to control the robot 403, in particular to control a movement of the robot 403.

In one embodiment, the robot control device 413 is not part of the robot system 401.

The robot control signals generated by the apparatus 301 are used, for example, by the robot control device 413 to control a movement of the robot 403 from the starting position to the target position along the determined collision-free trajectory on the basis of the robot control signals.

The robot system 401 also comprises a display device 415 comprising a touch-sensitive screen 417.

The display control signals generated by the apparatus 301 are output to the touch-sensitive screen 417, with the result that the latter accordingly displays the determined trajectory together with the environment of the robot.

A user can make inputs via the touch-sensitive screen 417. For example, the user can still adapt or change the displayed determined trajectory if necessary, via the touch-sensitive screen 417.

For example, provision is made for the first user input and the second user input and the third user input, respectively, to be captured by the touch-sensitive screen 417.

One embodiment provides for the display device 417 with the touch-sensitive screen 417 to not be part of the robot system 401.

FIG. 5 shows a machine-readable storage medium 501 which stores a computer program 503.

The computer program 503 comprises instructions which, when the computer program 503 is executed by a computer, for example by the apparatus 301, cause the latter to carry out a method according to the first aspect.

FIG. 6 shows the robot 403 both in a starting position 601 and in a target position 603.

A movement of the third robot arm 409 from the starting position 601 into the target position 603 is symbolically represented by an arrow with the reference sign 605.

A movement of the second robot arm 407 from the starting position 601 into the target position 603 is symbolically represented by an arrow with the reference sign 607.

A movement of the first robot arm 405 from the starting position 601 into the target position 603 is symbolically represented by an arrow with the reference sign 609.

A first object 611, a second object 613 and a third object 615 are arranged in an environment of the robot 403.

The determination of the collision-free trajectory from the starting position 601 into the target position 603 comprises, in particular, determining a separate collision-free sub-trajectory for each of the three robot arms 405, 407, 409.

Although it appears as if the first robot arm 405 would collide with the first object 611 during its movement from the starting position 601 into the target position 603, provision is made for the first robot arm 405 to move around the first object 601.

In summary, embodiments of the invention relate to a method for determining a trajectory of a robot from a starting position to a target position. The starting position and the target position are manually determined by a user in a real environment of the robot. A collision-free trajectory of the robot from the starting position to the target position is then determined on the basis of an environment of the robot.

Embodiments of the invention also relate to an apparatus, a robot system, a computer program and a machine-readable storage medium.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for determining a trajectory of a robot from a starting position to a target position, the method comprising:
receiving first user input signals representing a first user input at a first point in time stating that a first current position of the robot at the first point in time should be stored as the starting position;
storing the first current position of the robot as the starting position in response to the receiving of the first user input signals;
receiving second user input signals representing a second user input at a second point of time, which differs from the first point in time, stating that a second current position of the robot at the second point in time should be stored as the target position;
storing the second current position of the robot as the target position in response to the receiving of the second user input signals;
receiving environmental signals which represent an environment of the robot; and
determining a collision-free trajectory of the robot from the starting position to the target position on a basis of the environment of the robot.

2. The method as claimed in claim 1, wherein third user input signals are received and represent a third user input at a third point in time stating that a third current position of the robot at the third point in time should be stored as an intermediate position, further wherein the third point in time differs from the first point in time and differs from the second point in time, and the third current position of the robot at the third point in time is stored in response to receiving the third user input signals, further wherein the trajectory is determined on a basis of the stored intermediate position in such a manner that the stored intermediate position is on the trajectory.

3. The method as claimed in claim 1, wherein robot control signals for controlling the robot are generated on a basis of the determined trajectory and on a basis of a predefined maximum speed and are output in such a manner that, when controlling the robot on a basis of the robot control signals, the robot moves from the starting position to the target position along the determined trajectory at the predefined maximum speed.

4. The method as claimed in claim 1, wherein display control signals are generated on a basis of the determined trajectory and on the basis of the environment of the robot and are output in such a manner that, when controlling a display device a basis of the display control signals, the determined trajectory is displayed together with the environment of the robot by the display device.

5. The method as claimed in claim 1, wherein boundary condition signals representing a boundary condition for the trajectory to be determined are received, and the trajectory is determined on a basis of the boundary condition.

6. The method as claimed in claim 5, wherein, if a trajectory which satisfies the boundary condition cannot be determined, the boundary condition is configured in such a manner that it is possible to determine a trajectory which satisfies the configured boundary condition, with the result that the trajectory is determined on a basis of the configured boundary condition.

7. The method as claimed in claim 1, wherein a plurality of collision-free trajectories respectively comprising a shortest trajectory and/or a fastest trajectory and/or a smoothest trajectory from the starting position to the target position are determined.

8. The method as claimed in claim 1, wherein robot parameter signals representing a robot parameter of a further robot in the environment of the robot are received, wherein the trajectory is determined on the basis of the robot parameter, wherein the robot parameter is an element selected from the following group of robot parameters: further starting position of a further trajectory of the further robot, further target position of a further trajectory of the further robot, further trajectory of the further robot from a further starting position to a further target position, dimension of the further robot, contour of the further robot.

9. An apparatus which is configured to carry out the method as claimed in claim 1.

10. A robot system comprising a robot and the apparatus as claimed in claim 9.

11. A computer program comprising instructions which, when the computer program is executed by a computer, cause the latter to carry out a method as claimed in claim 1.

12. A machine-readable storage medium which stores the computer program as claimed in claim 11.
